(19) United States
(12) Patent Application Publication
(10) Pub. No.: US 2003/0004997 A1
(43) Pub. Date: Jan. 2, 2003

(54) Method for online personalization of greeting cards

(76) Inventors: Steven Parker, Toronto (CA); Charles Jennings, Toronto (CA)

Correspondence Address: DENNISON ASSOCIATES, 133 RICHMOND STREET WEST, SUITE 301, TORONTO, ON, M5H 2L7, CA

(21) Appl. No.: 09/991,679

(22) Filed: Nov. 26, 2001

(30) Foreign Application Priority Data
Jun. 28, 2001 (CA) 2,351,780

(51) Int. Cl. G06F 15/00

(52) U.S. Cl. 707/513; 705/27; 705/14

(57) ABSTRACT

A system and method for providing convenient manufacture and delivery of customized greeting cards uses the convenience and ready access of the Internet or other widely available network. The website allows a user to enter information used to assist in the selection of an appropriate expression and image. An advertisement, sales promotion or product sale can be associated with the greeting card and used to subsidize the cost of the greeting card. In one embodiment an advertisement is associated with the greeting card and printed as part of the greeting card. The printed greeting card and advertisement are delivered by mail or other delivery service. The website is also designed to allow users to seek assistance from others with respect to expressions and images.

### FIELD OF THE INVENTION

The present invention is directed to a method and system for creating and producing customized greeting cards over a wide area wired or wireless network, in particular the Internet.

### BACKGROUND OF THE INVENTION

Greeting cards have become an important element for expressing good wishes with respect to the celebration of a particular event. In some cases, a greeting card alone is used and in other cases a gift is associated with the greeting card. Conventional card and gift shops have a host of preprinted greeting cards (including the text sentiment or expression) for different occasions. The purchaser attends at the store location, reviews the various cards in the appropriate seasonal or everyday category, and purchases the selected card. Typically, the card is sold in the range of US $2.00 to US $4.00. This price for a printed substrate of card stock initially appears expensive relative to the cost of the card, however, when one considers the required overhead for operating the store, the amount of waste and the turnover rate for the store the price is somewhat more appropriate. In many cases, the availability of an appropriate card that suits the person and the occasion renders the price tolerable. Typically, these types of retail outlets also include giftware in the hope that a secondary higher prices sale can occur.

Electronic systems offering forms of card personalization started appearing in the late 1980s and throughout the 1990s. Specialty greeting card stores such as Your Expression established in 1988 provided personalized greeting cards through a local area network system. From a database of expressions categorized by occasions, the greeting card messages would be further personalized by interaction between the customer and the retail attendant and then printed on a paper insert which would be affixed inside a blank greeting card.

Standalone kiosks of Hallmark Cards or American Greetings Corporation presented retail customers with the ability to select a card image and type a personalized message with the resulting greeting card printed on-demand while the customer waited. These electronic systems did not offer an extensive database of messages categorized by occasion or by card face. The card fronts were graphic “vector” images. These systems were not capable of printing high-resolution, photographic “bitmap” images.

More recently, a number of websites are available which allow the personalization of an electronic or e-card which is transmitted to the recipient by e-mail. These cards allow for the selection of a particular image, the selection or creation of a particular expression and also sometimes include audio or video files associated therewith as part of the presentation. These cards are not normally printed and are transmitted by e-mail to the recipient. Although e-cards have become popular, they are generally recognized as being in addition to the conventional card exchange and/or card gift exchange process. Therefore, generally e-cards have not been accepted as a replacement or substitute for the conventional printed card, particularly on important occasions.

In addition to e-cards, greeting card online services over the Internet offer web customers the ability to select an image or graphic for the front of a greeting card and offer a standard greeting to be printed with the selected card or alternatively offer the ability to type in a personalized message. These sites do not, however, offer a wide selection of alternative messages or expressions associated with multiple cards or occasions.

Although the selection of a card and the mailing of a card to the recipient provides recognition of the thought and good wishes of the sender, the card alone may not be sufficient. Flower delivery and other gift delivery services provide a convenient service which provides a further indication of the sender's recognition of the event.

In many cases, the card sender or senders are quite busy and although they wish to give the most appropriate card and the most appropriate gift, there are too many factors with respect to the individual's taste, size, wardrobe and other circumstances which complicate the issue and often lead to a selected gift being returned. Gift certificates partially overcome this issue but are not recognized as being personal or representing considerable thought.

In the case of greeting cards for corporate use and occasions, corporations have had to purchase greeting cards through the same retail channels as consumer greeting card purchasers. Typically, consumer cards do not lend themselves to use for corporate occasions. The requirement to go to retail outlets is usually not time effective for corporations, and the cards and expressions do not tend be appropriate for corporate use. As a result, the corporate market has not been particularly well serviced by the greeting card industry. New Internet-based personalized greeting card services have offered alternatives that meet some of the shortcomings of the retail consumer chain.

The present invention seeks to address a number of these issues and provide a method and system which allows the card selection and message personalization over the Internet and with the resulting card printed card on-demand and mailed to the recipient in a cost effective manner. Optionally, the present invention allow a customized combination greeting card and gift certificate or gift to be delivered to the recipient. It also seeks to address the special needs of corporations sending greeting or acknowledgement cards on a private-label basis with optional marketing and other information printed as part of the card.

### SUMMARY OF THE PRESENT INVENTION

A system for creating customized greeting cards according to the present invention comprises a web server having associated therewith a database of categorized expressions, a database of categorized images, a selection process for entering user information used to search each database to form a reduced portion of each database that may be appropriate for selection by the user, means for a user to identify a particular expression and a particular image to thereby define a customized greeting card, an arrangement for associating with the customized greeting card a related sale or promotion, a printing arrangement for printing the customized greeting card and a delivery arrangement for delivering the printed greeting card to a recipient.

The delivery arrangement of said system according to an aspect of the invention uses a postal address.

According to a further aspect of said invention the customized greeting is associated with a sale of a gift product.

In yet a further aspect of said invention the customized greeting card is associated with an advertisement of a party or parties different from the manufacturer of the card.

In yet a further aspect of the invention the advertisement is a sales and marketing promotion.

In a different aspect of the invention the customized greeting card is associated with a gift certificate delivered with the card. Preferably the gift certificate is attached to said card.

In yet a further aspect of the invention the gift certificate is attached as a third panel of a normal two panel greeting card. In one aspect of the invention the greeting card is provided free to the user.

In a further aspect of the invention, the system is adapted for use by corporations. In this case, a database of corporate marketing information is included. The resulting card for corporations included customized marketing information selected from the database.

In an aspect of the invention a cost of manufacture of said greeting card is partially funded by said associated sale or promotion by advertisers.

In an aspect of the invention said website includes advertisements viewed when using said website.

In an aspect of the invention an email to the sender and the recipient confirming the completion of the printing of the card and/or mailing of the card will include additional marketing or promotional information provided by the advertiser including a link to the advertiser's website.

In yet a further aspect of the invention, a corporate customer will have their logo and slogan printed on the back of the greeting card creating a private-labeled version for corporations.

In a feature of the private-labeled corporate greeting cards, the corporation will also have the option to print additional marketing or promotional information on panels of the greeting card.

According to a feature of the system the website, based on user provided information, makes a series of recommendations of appropriate gifts available using said website.

According to a feature of the system at least one of said images and said expressions are categorized by occasion.

According to a further feature the categorization of said expressions is used as part of the categorization of said images.

According to a further feature the card images will be linked to specific expressions appropriate for the card image.

According to a further feature, the creation a new expression or further personalization of an existing expression from the database will be completed by keyboard entry or by voice activation software.

The online system will be accessible over a wired or a wireless wide area network including the Internet.

### BRIEF DESCRIPTION OF THE DRAWINGS

The preferred embodiments of the invention are shown in the drawings wherein

FIG. 1a is a perspective view of a customized card and FIG. 1b shows a card with a paper insert.

FIG. 2 is a perspective view of a customized card showing the back panel;

FIG. 3 is a perspective view of the inside of a three panel greeting card gift certificate;

FIG. 4 is a perspective rear view of the a three panel greeting card gift certificate;

FIG. 5 is a view of a printed envelope;

FIG. 6 is a perspective view of a modified three panel greeting card with associated printed advertising or promotional material;

FIG. 7 is a perspective view of a previously sealed envelope which opens exposing the printing on an interior surface;

FIG. 8 is a perspective view of an envelope with advertising or a promotion printed thereon;

FIGS. 9a and 9b illustrate a three panel “private-labeled” greeting card for use by corporations with associated printing of corporate marketing and promotional information.

FIG. 10 is a schematic overview of users accessing an online greeting card website providing custom printed greeting cards

FIG. 11 is a schematic of the custom expression creation process

FIG. 12 is a schematic of the custom card front creation process

FIG. 13 is a schematic overview of a website offering custom consumer greeting cards with and without advertising

FIG. 14 is a schematic overview of a corporate greeting card website offering private-labeled personalized greeting cards.

FIG. 15 is a schematic of a personalized greeting card gift certificate website.

FIG. 16 is a schematic overview of the retailer's website with respect to processing custom printed greeting card gift certificates.

FIG. 17 is a schematic overview of the fulfillment process.

### DETAILED DESCRIPTION ACCORDING TO THE PREFERRED EMBODIMENTS OF THE PRESENT INVENTION IN WHICH

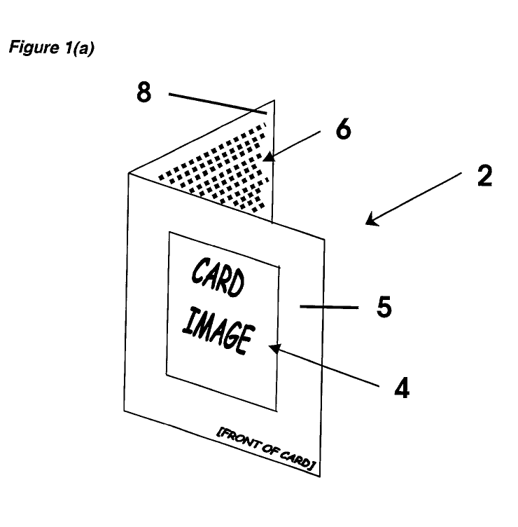

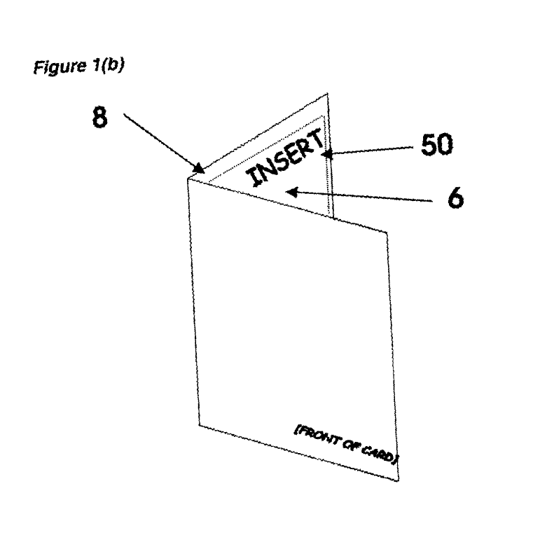

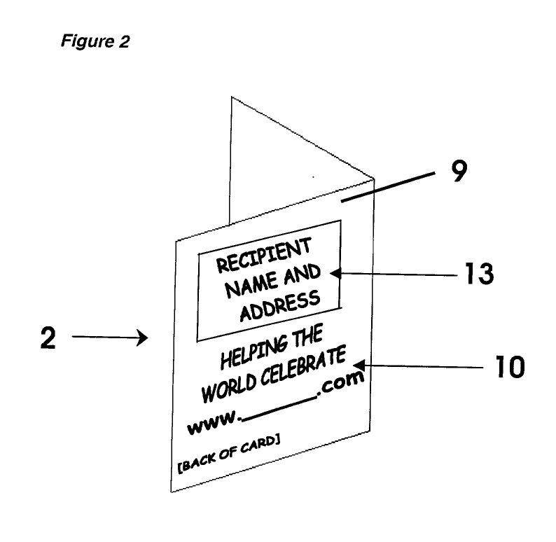

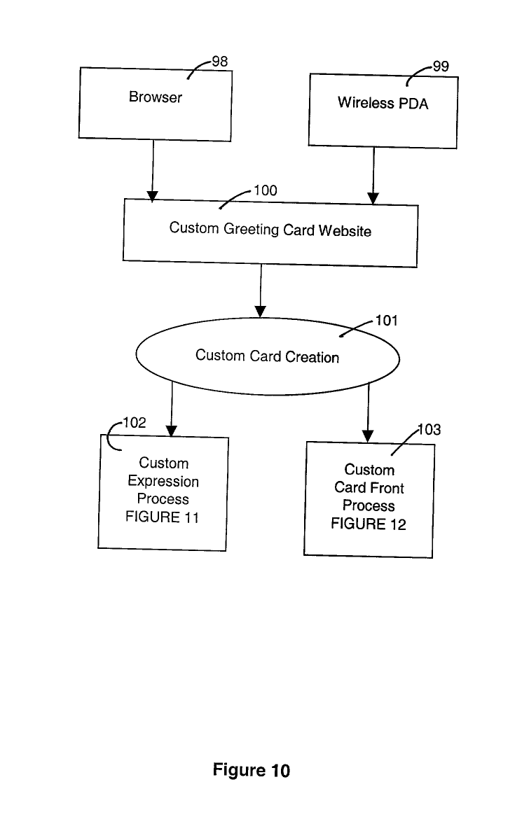

The present system embodies an Internet website where in FIG. 10 greeting card users access the website through their browser 98 or their Personal Digital Assistants (“PDA”) 99. At the website 100 the users can create custom greeting cards. FIGS. 1(a) and 2 show the customized greeting card 2 having a selected image customized with or without text 4 on a front panel 5 of the card and a customized expression 6 on the inside of the inside panel 8 of the card. Alternatively, in FIG. 1(b) the customized expression 50 is printed on a paper insert that is affixed inside the greeting card.

In the custom card creation process at 101 in FIG. 10 the user, or card sender, elects to start at either the custom expression creation process 102 or the card front creation process 103.

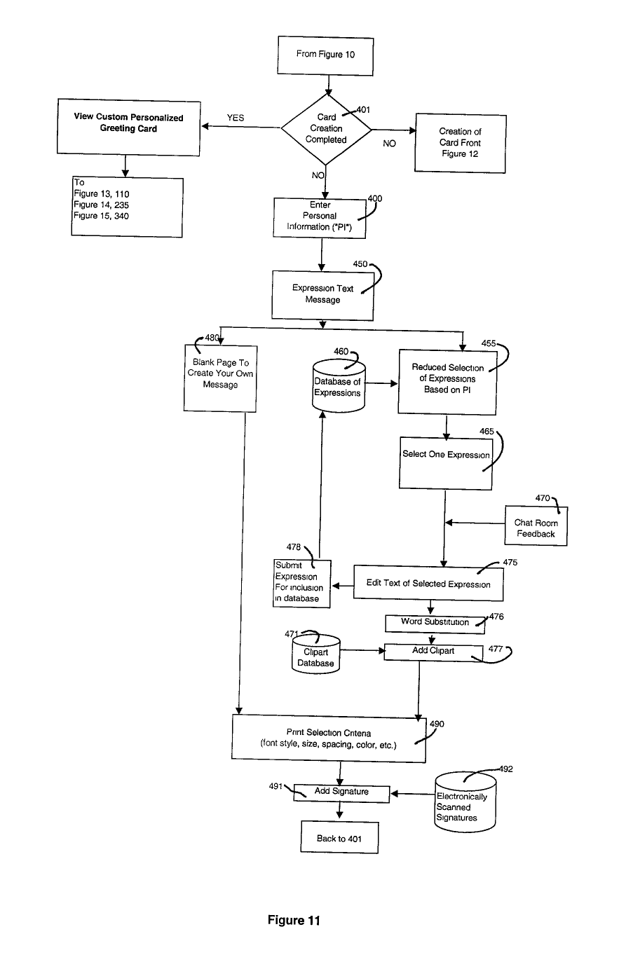

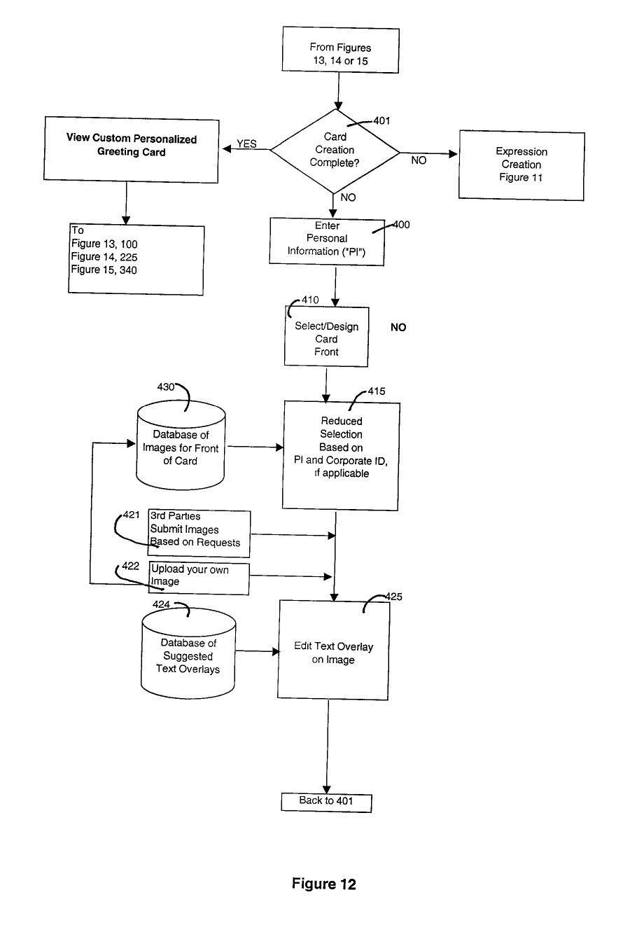

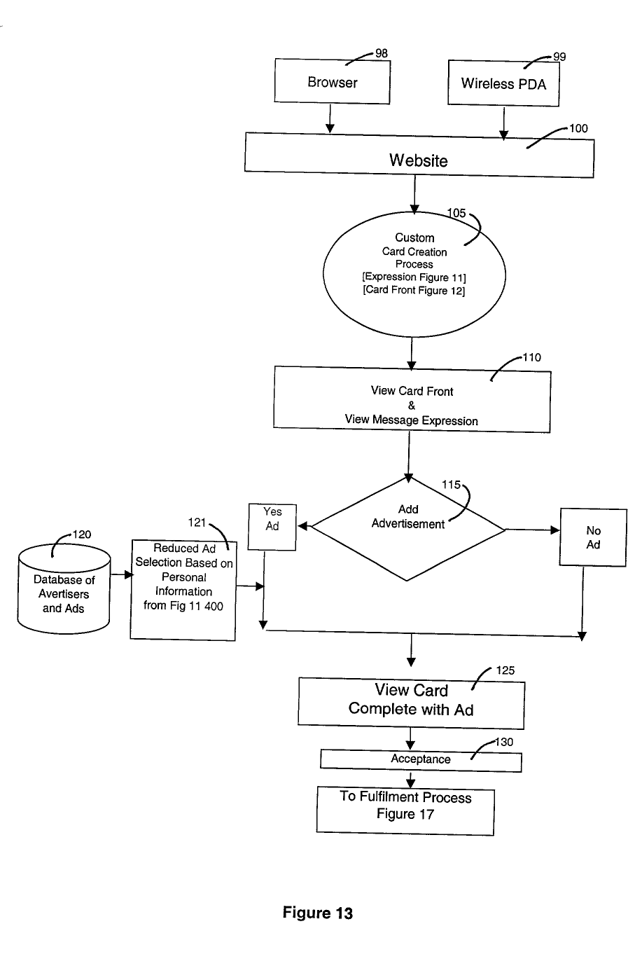

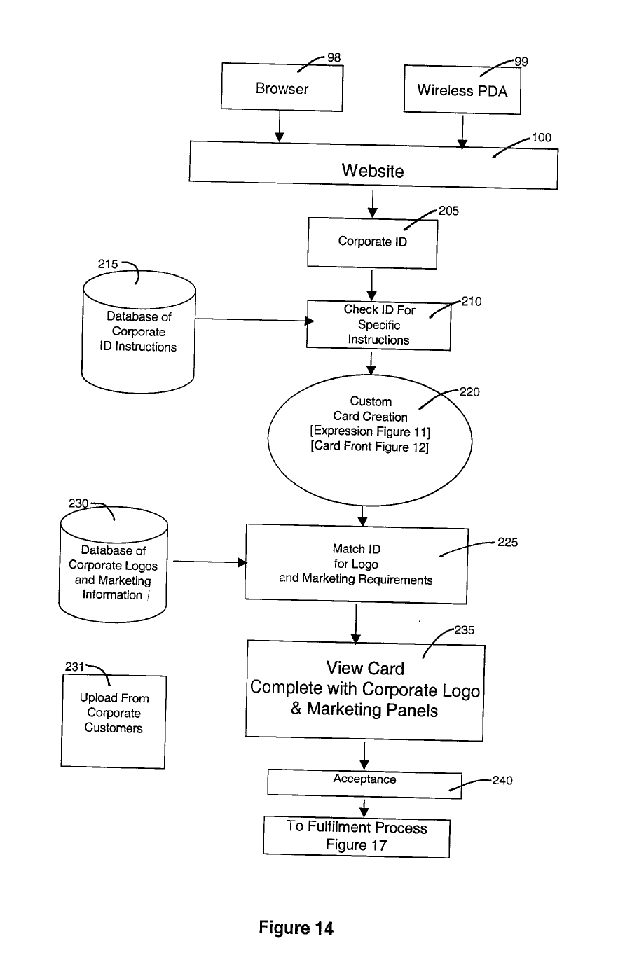

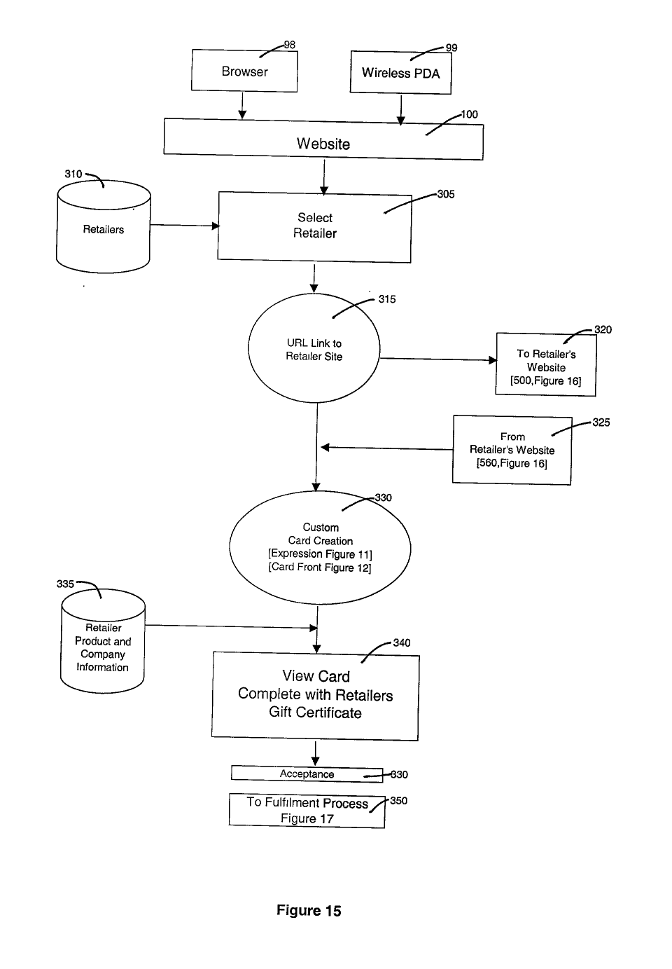

In either case, the user will be requested for additional Personal Information at 400 FIGS. 11, 12 for purposes of customizing the card expression (or message) and the card front. This Personal Information would include selection or indication of the card occasion (birthday, anniversary, Christmas, Valentines, etc), the relationship of recipient to the sender (eg mother, father, niece, stepson, etc.), the emotional mood (eg humorous, romantic, complimentary, religious, etc.) and number of years celebrated by an event (eg birthday, anniversary). This Personal Information 400 will be used at various stages to simplify the customization process through a reduction 455 of the expression database 460 FIG. 11, and a reduction 415 of the image database 430 FIG. 12.

In FIG. 11 text expressions may be stored generically in the database 460 without, for example, inclusion of the recipient's name, the birthday date or anniversary date. The user can be requested to provide certain information before searching the expressions database. Personal Information such as the sender-recipient relationship, whether the card is being sent from one person or more than one person to one or more than one person, where applicable whether the occasion celebrates a specific number of years, etc. This information will be used to automatically transform the generic expression stored in the database to a personalized version when presented to the user through their browser. For example, “Wishing you a Happy Birthday” could be presented to the user as “Brother, We wish you a Happy 21^{st} Birthday on this Special Day Jun. 28, 2001 ”. The verb tense will also be automatically changed depending on the number of people representing the sender information. The user can also have the ability to further edit the expression to suit their situation 475. Alternatively, the text expression may be stored with a specific relationship (eg brother, mother, etc) but based on the specified actual relationship information as provided at 400 a search and replace activity will be performed transforming the expression database relationship to the required relationship.

It is also possible for the user to enter a chat room indicated at 470 to provide further customization and/or suggestion by other users. In addition to being used by the greeting card sender in their personalized greeting cards, these expressions can also be submitted by the sender for inclusion in the entire expression database 478 with recognition as the author. The website would permit visitors to search the databases by the name of a creator.

A database of clipart images 471 can be used to add imagery to the text expression, for example, a drawing of a heart for romantic expressions, a birthday cake or candles for birthday's, etc.

At 490 the user can edit the text presentation by choosing font sizes, styles, color, spacing and layout positioning. By default the text is center justified. It is also possible to allow the sender to vary the types of signatures using different fonts and colors available from the system.

The alternate arm of the process is shown at the customized selection 480. At this point the user is preferably presented with a free form text creation process where the user can simply create their own expression without first selecting an expression from the database 460.

The customized expression can also include customized signatures 491 of the sender created electronically from a sample signature of the sender and stored in a database 492. The system can include uploading of signatures to the website or receipt of signature by e-mail or by facsimile and scanning them, into a database.

In FIG. 12 the card front can be selected or customized at 410. Based on certain of the Personal Information such as the card occasion or search by keyword, the user is provided a reduced database 415 of image choices which are tagged internally by identification subject categories (golf, flowers, etc).

A keyword search based on image content also provides a reduced database of image choices. As well, the user can post certain criteria or proposals and free lance photographers or graphic artists at 421 can provide uploaded electronic images for use by the sender in creating the greeting card with recognition of the photographer-donor of the image being given on the card or the website.

It is possible as indicated at operation 422 to allow the sender to upload a particular image for their own use in creating the card. The system also includes the ability for visitors to the website to submit their images for inclusion in the database 430 for general use of all visitors. In certain cases, the donors may be compensated if desired. The database of expressions and images would include information identifying the creator-donor.

At 425 the images can also be edited by the user to include and position text overlay, for example, “Happy 49^{th} Birthday” John, or to also edit the image itself using certain templates 424 to facilitate the ease of the editing or combining images.

It can be appreciated from the above that a customized card including a customized image and customized expression is defined by a series of steps on the website.

In another version of the custom greeting card, the exterior surface of the back panel 9 as shown in FIG. 2 includes an advertisement or corporate logo and slogan 10 of someone other than the card manufacturer. This advertisement and advertiser's logo preferably relates to the greeting card event. For example, a bon voyage card with a travel company advertisement.

This advertisement can take many forms but the basic concept is part of the card preferably the back panel of a two-panel greeting card is used as an advertising or marketing surface. Preferably the advertiser and the particular advertisement are selected based on the particular card celebration or event. In addition to associating particular advertisers with particular events, advertisers could be selected based on the particulars of the recipient of the card, the geographical location of the recipient of the card and/or other information that is derived during the customizing process of the greeting card or otherwise available.

One of the problems facing advertisers is the ability to reach a particular target market. It is often difficult to have all of the information with respect to a particular target market and reaching the target market at the time an event might trigger a purchasing decision. Most systems for reaching a particular target market additionally contact a large part of the population which is outside the target group or not close to the time that a buying decision is being made.

In FIG. 13, the Personal Information obtained from the sender in the Custom Card Process 400 in FIGS. 11 & 12 is used to select an appropriate advertiser for the consumer custom greeting card. Age, address and personal information with respect to the recipients, as well as knowledge about possible purchasing opportunities related to the greeting card occasion determined in the personal information process allow classification of senders and recipients such that advertisers have increased confidence that the target market is being reached. The advertisement allows the cost of the card and possibly the delivery of the card to be partially or fully funded by advertising revenues. It is also possible that general goodwill promotions without a specific offer to the recipient will be of particular interest to international companies or larger companies. Such advertisements promote general goodwill 10 and branding with respect to the corporate entity.

In the foregoing instance, the advertisement is chosen by the website for the sender based on pre-determined criteria 121 related to the Personal Information. In another instance, the sender may be presented with a choice of advertisers. The sender then considering the interests of the recipient may wish to select a particular advertisement or advertiser from a subset of those identified within the database 120 FIG. 13 of advertisers who are prepared to subsidize the cost of the card. The sender may know that the recipient has a particular like or dislike with respect to one corporate entity and the sender could choose an advertiser as appropriate.

It is anticipated that certain advertisers will be prepared to fully fund the cost of the card associated therewith rendering the card free to the sender. Possibly the advertiser would be prepared to fund the delivery cost as well. Thus to the sender who is prepared to accept some type of acceptable advertisement on the back panel of the card, the cost of the card and the delivery of the card to the recipient may be free.

Alternatively, the user can opt for a customized printed greeting card without advertising and merely arrange to pay an appropriate retail price determined by the website.

FIG. 5 shows an alternate arrangement where the customized card of FIGS. 1 and 2 can be used in combination with the customized envelope 30. The inside of the envelope can include a coupon or other advertisement as shown as 31 on the inside of the envelope. This coupon could be for redemption of free merchandise or a special two for one offer as two examples. This advertisement can also be customized by the information required to personalize the card and transmit the card to the recipient.

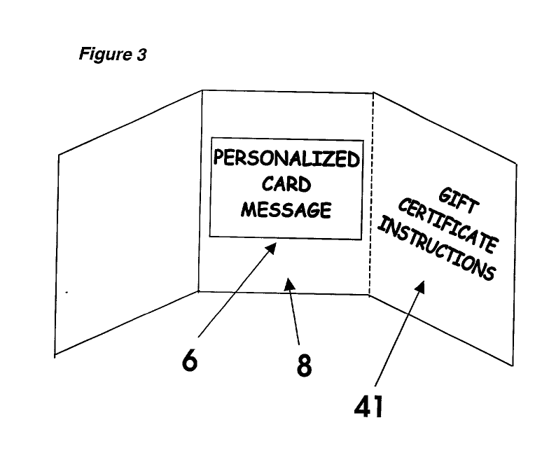

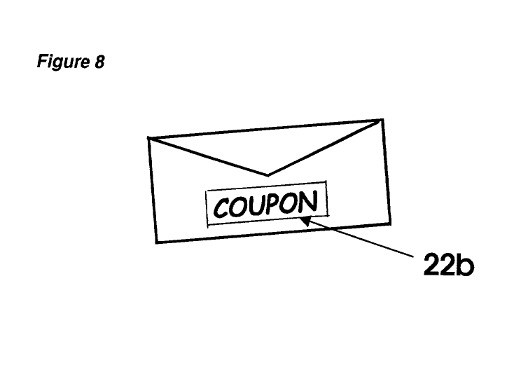

In the embodiment of FIG. 8 the coupon or advertisement is provided on the envelope 22b. This can be used in conjunction with the customized card of FIGS. 1 and 2 or the combination greeting card/gift certificate of FIG. 3 or any of the other embodiments as discussed later. It can also be appreciated that if one wishes to send a traditional card without any advertising support on the rear surface or as part of a removable panel, this is also possible and a standard envelope can be used.

In another instance of online custom printed greeting cards, FIG. 14 defines an online system to provide three-paneled, private-labelled greeting cards. Corporations may want their employees to send private-labelled personalized greeting cards thus promoting their corporate brand and providing corporate marketing information to the recipient of the card who may be a customer, potential customer, supplier, or other important contact of the corporation.

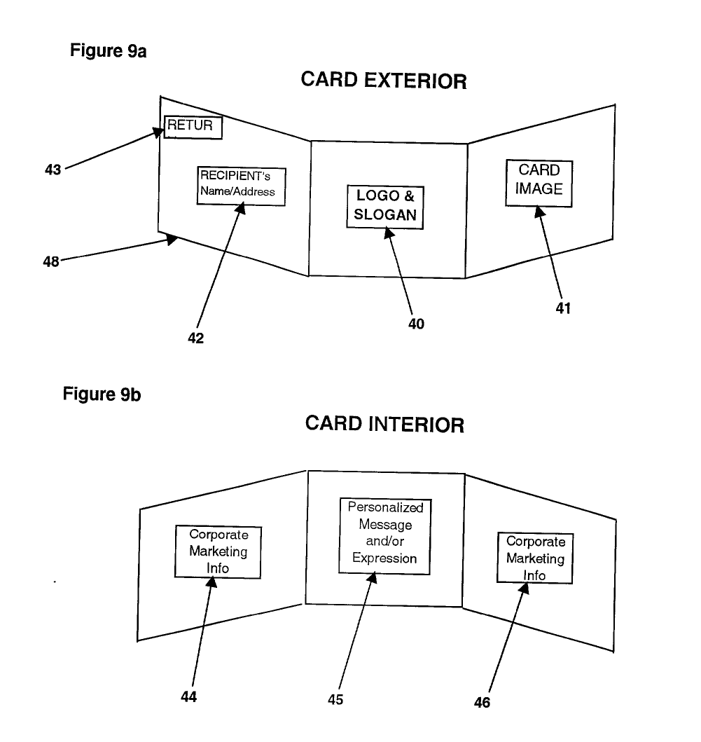

In this case, visitors to the website would be identified by a corporate and employee identification number 205. They would use the online greeting card service including the customization of greeting card messages and card images as described but have the cards printed with their corporate logo and slogan 40 on the middle panel of the exterior side of the card shown in FIG. 9b. Additionally, they may choose to have pre-determined corporate marketing and other information 230 printed on the left interior panel 44 and/or the right interior panel 46 (FIG. 9a). The recipient address 42 and sender return address 43 would be printed on the left exterior panel. The three-panel card would be folded and sealed at the edge such that the address panel 48 would provide the mailing information without necessarily the need for an envelope.

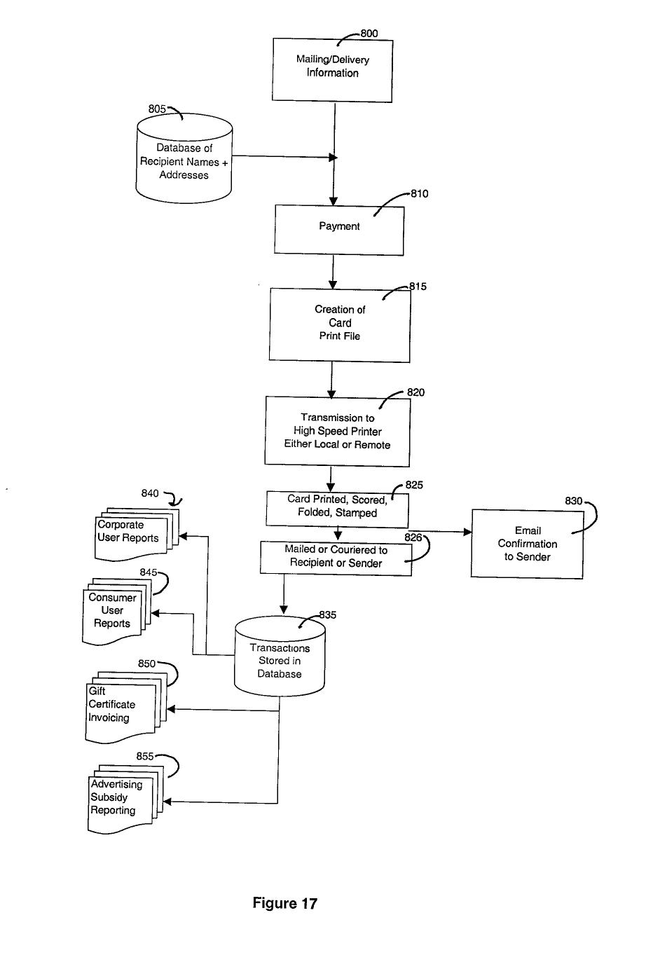

The corporate customer would have the benefit of its employees sending private-labelled greeting cards and promoting the company and its products and services to recipients of the cards and to others who may view the card in the delivery process. Customer corporations would be able to upload their corporate marketing information tailored to the website's specifications and added to the database 230 and automatically available for use by their employees. The custom private-labelled, marketing card would be viewed on the website at 235, accepted at 240 and printed, folded, sealed and mailed in the Fulfilment process defined in FIG. 17 as discussed below.

In another instance of the three-paneled greeting card, a personalized greeting card gift certificate is defined in FIG. 12 where at 305 a host of different retailers can be selected from and different amounts can be provided as part of the gift certificate which preferably includes a high-quality, photographic image of the particular product which the sender thought would be appropriate. This gift certificate can be produced on the additional panel 22 of FIG. 3.

Gift certificates typically do not provide an image of a suggested gift made by the sender on behalf of the recipient of the gift certificate. The addition of a photographic quality image of the gift selected from a retailer's website elevates the typical impersonal nature of a gift certificate for money to a very personal gift certificate akind to actually giving a physical gift.

Because it alters to the gift giving process such that the recipient confirms the acceptance of the actual gift before physically receiving the gift, it has the added advantage to the retailer of avoiding costly returns of physical goods and has the advantage to the recipient of the gift certificate of avoiding the time required to return the gift.

In other circumstances, it may be desirable to introduce a gift certificate that may include the image of a product from a particular retailer but has more universal application. This could include a gift certificate which will be accepted by a number of retailers which can be identified on the gift certificate but is offered in combination with a financial institute. The recipient can use this effectively as part of the cash payment or in the event that the suggested gift is not appropriate the gift certificate can be deposited at his own financial institute.

The gift certificate greeting card promotes the associated retailer who is willing to at least partially subsidize the cost of the card. Depending upon the value of the gift or the gift certificate this could include the full subsidy of the card including the delivery costs.

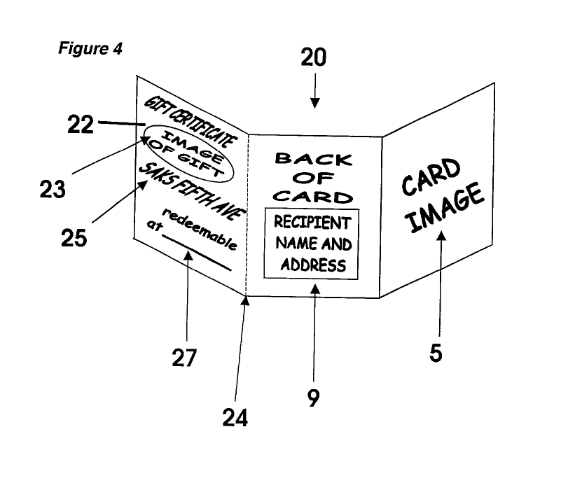

FIGS. 3 and 4 shows a combination greeting card and gift certificate 20. The greeting card is similar to the greeting card 2 but includes a third panel 22 which includes a gift certificate. In a preferred embodiment of the invention the gift certificate 22 includes a high quality photographic bitmap image 23 of the particular gift that the sender has chosen as appropriate for the recipient. The gift certificate also includes the corporate identity 25 of the retailer where the product in the image 23 can be purchased and optionally includes alternative retailers where the gift certificate can be used.

The combined customized card and the customized gift certificate are placed in the envelope FIG. 5 which includes the address 34 of the recipient, the return address of the sender 31 and the appropriate postage or payment of delivery services is provided as indicated by the postage stamp 32. Alternatively, the greeting card or greeting card gift certificate are printed with the name and mailing address of the recipient of the mailing such that this information will show through a window envelope eliminating the need to print on the envelop or label and also eliminating the need to match specific envelopes with specific greeting cards. Alternatively, the greeting card is folded and sealed such that the address at 9 in FIG. 4 provides the mailing information without the need for an envelope.

With the combination of greeting card/gift certificate of FIG. 4 the recipient receives from the sender a customized greeting card which includes the gift certificate 22 which can be separated from the card by tearing along the perforated line 24. The sender has provided not only a customized card but has also provided a gift certificate with a suggested gift and photographic quality image of the gift.

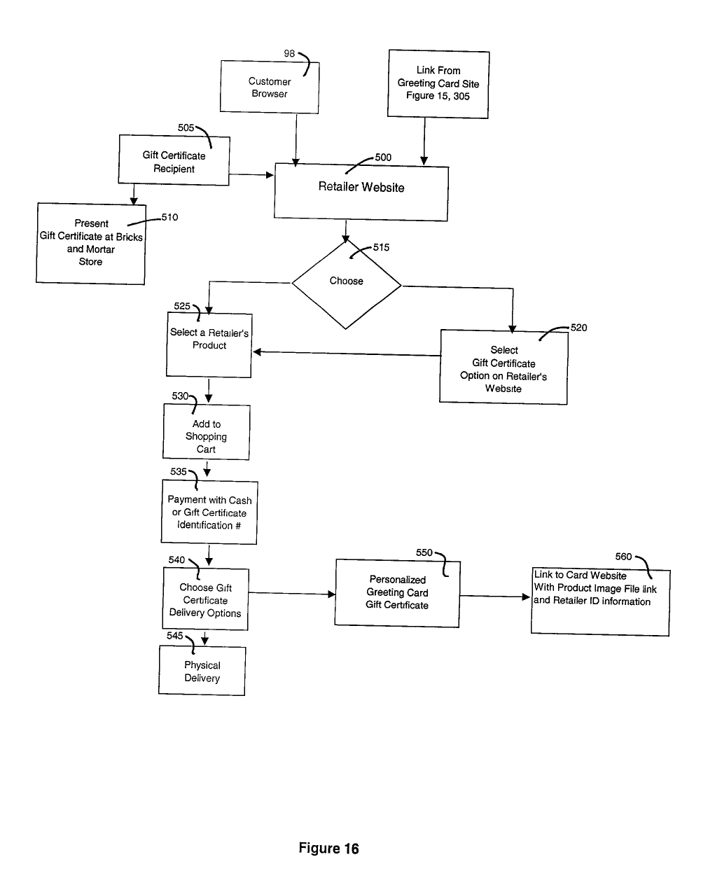

A personalized greeting card gift certificate user could enter the process to purchase the gift certificate through the card website 100 on FIG. 15 or alternatively through the retailer's website 500 on FIG. 16. If entering through the card website the user will be directed to the retailer's website 315 in order to go through the process of identifying which product they would like to have printed on the gift certificate as their suggested gift to the recipient of the gift certificate. The product is printed based on a system of capturing the image file reference information from the retailer's website 560 FIG. 16 as the user chooses the product to be added to the retailer's shopping cart and chooses the gift certificate delivery method.

The gift certificate portion has a printed web URL address that links the recipient directly to the product visual (505 FIG. 16) and information as shown and described on the retailer's website where the recipient of the gift certificate can then proceed to select the suggested product or alternatively choose another and proceed to checkout at 530 FIG. 16 using the unique gift certificate number printed on the gift certificate as the form of payment. Alternatively, the gift certificate can be detached from the greeting card and redeemed for the product or other product at the retailer's store at 510 FIG. 16 thereby using the web to promote traffic back to its brick and mortar retail chain. The system would also include for the benefit of the recipient of the gift certificate a means whereby the retailer would keep the product item printed as a suggested gift on the gift certificate in stock for a specific number of days. If this is determined not to be appropriate the gift certificate can be used for redemption at the preferred retailer identified as 25 and preferably a number of alternative retailers are provided at 27.

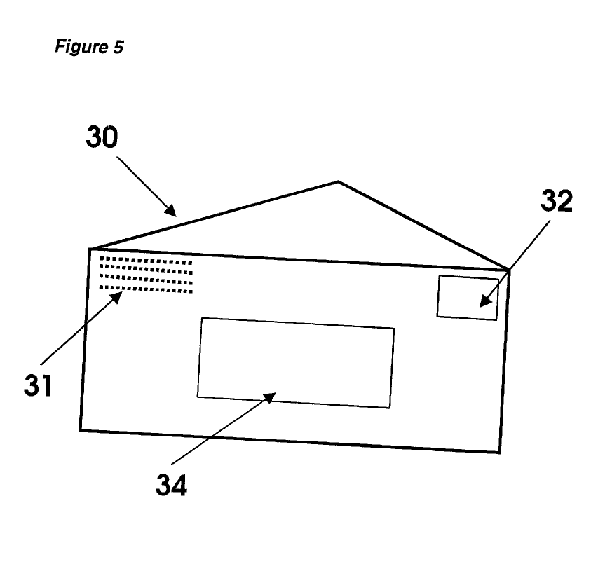

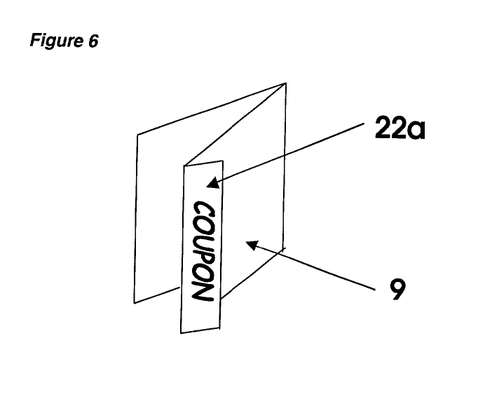

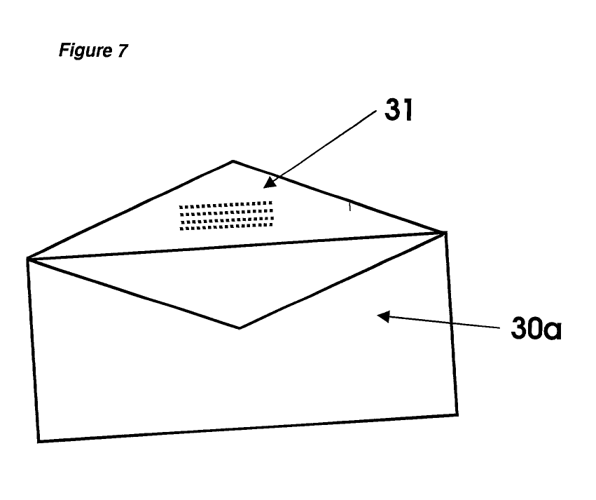

A variation of the gift certificate of FIG. 3 is shown in FIG. 6 where a smaller removable panel 22a is attached to the back panel 9. This type of removable panel could be used to promote a two for one movie option or a two for one dinner arrangement or perhaps a special buying incentive. This buying incentive could be tied to the celebration and could even include an expiry date.

FIG. 17 shows the fulfillment process whereby the customized consumer greeting card FIG. 13, the private-labeled corporate custom greeting card FIG. 14, or personalized greeting card gift certificate FIG. 15 will be printed by a high quality printer either locally or remotely from the information collected during the custom card processes and captured into PDF files. It is also apparent that a number of printing locations can be networked and a printing location that has capacity or geographic preference can be selected. A printing system can also be associated with one or more stores such as florists.

The card will be sent by the website directly to the recipient, or alternatively to the user to be delivered to the recipient, using an appropriate delivery service such as mail or courier 825. Some users of the website will only wish to send a customized card or a standard card to the recipient, whereas other users may wish to associate a gift, gift certificate or a more universal gift certificate.

The website shows transactions stored in various databases 835 generating various reports as additional services for members. For example, a transaction history of the details of cards sent by a member 840 and 845. The transaction history could contain the date, the recipient name, which card image and the text of the expression. The website could also provide an e-mail or other reminder service permitting users to set up dates on which to be reminded that a card should be sent to a specific recipient. Invoicing reports to retailers for gift certificates 850 and advertising subsidy reporting 855 are other reporting examples.

Additionally, e-mail confirmation 830 including a copy of the card or link to display of the card to the sender can be provided when the card and any gift or certificate is completed and delivered or placed in the hands of the delivery service.

Although various preferred embodiments of the present invention have been described in detail, it will be appreciated by those skilled in the art that variations may be made without departing from the spirit of the invention or the scope of the appended claims.

The embodiments of the invention in which an exclusive property or privilege is claimed are defined as follows:

1. A system for creating customized greeting cards comprising a web server having associated therewith a database of categorized expressions, a database of categorized images, a selection process for entering user information used to search each database to form a reduced portion of each database that may be appropriate for selection by the user, means for a user to identify a particular expression and a particular image to thereby define a customized greeting card, an arrangement for associating with the customized greeting card a related sale or promotion, a printing arrangement for printing the customized greeting card, and a delivery arrangement for delivering the printed greeting card to a recipient.

2. A system as claimed in claim 1 wherein said delivery arrangement uses a postal address.

3. A system as claimed in claim 1 wherein said customized greeting is associated with a sale of a gift product.

4. A system as claimed in claim 1 wherein said customized greeting card is associated with an advertisement of a party different from the manufacturer of the card.

5. A system as claimed in claim 4 wherein said advertisement is a sales promotion.

6. A system as claimed in claim 1 wherein customized greeting card is associated with a gift certificate delivered with the card.

7. A system as claimed in claim 6 wherein said gift certificate is attached to said card.

8. A system as claimed in claim 7 wherein said gift certificate is attached as a third panel of a two panel greeting card.

9. A system as claimed in claim 1 wherein a gift is sent with said card and said gift is selected using said website.

10. A system as claimed in claim 1 wherein said greeting card and the delivery thereof are free to said user.

11. A system as claimed in claim 1 wherein a cost of manufacture of said greeting card is partially funded by said associated sale or promotion.

12. A system as claimed in claim 11 wherein said website includes advertisements viewed when using said website.

13. A system as claimed in claim 9 wherein said website based on user provided information makes a series of recommendations of appropriate gifts available using said website.

14. A system as claimed in claim 1 wherein at least one of said images and said expressions are categorized by occasion.

15. A system as claimed in claim 1 wherein the categorization of said expressions is used as part of the categorization of said images.

16. A system as claimed in claim 1 wherein said sale or promotion is an advertisement partial selected based on the information entered by the user.

17. A system as claimed in claim 1 wherein said website includes a database of advertisers and related criteria used to pair an advertisement with an appropriate customized greeting card.

18. A system as claimed in claim 17 wherein the cost of the advertisement paired to a greeting card is used to subsidize the cost of the greeting card charged to the user.

19. A system as claimed in claim 1 including a database of corporate marketing information.

20. A system as claimed in claim 20 including databases of categorized expressions and categorized images appropriate for corporate greeting or acknowledgement cards.

21. A process of creating customized corporate communications comprising
accessing a web server having associated therewith a database containing a series of specific corporate communications associated with a particular corporate/client event and a database containing a series of marketing communications associated with the wares and/or services of the corporation,
selecting an appropriate specific corporate communication and providing client information to allow sending of said corporate communication to at least one client,
producing a printed customized corporate communication having said selected specific corporate communication and at least one marketing communication associated with the wares and/or services of the corporation, and
sending said printed customized corporate communication to an address associated with said client information.

22. A process as claimed in claim 21 including said web server including a database of corporations authorized to produce customized communications and said database of specific corporate communications and said database containing said series of marketing communications are divided to be specific to particular corporation.

23. A process as claimed in claim 22 wherein each printed customized communication includes identification of the corporation as the producer of the printed customized communication.

24. A process as claimed in claim 21 wherein said printed customized communication is a greeting card or an acknowledgement card.

25. A process as claimed in claim 24 wherein said specific corporate communication includes a database of images and said process includes selecting of an image of said database of images as part of the printed customized communication.
